(19) United States
(12) Patent Application Publication
(10) Pub. No.: US 2024/0394047 A1
(43) Pub. Date: Nov. 28, 2024

(54) SYSTEMS AND METHODS FOR MANAGING ONE OR MORE BUILDING BLOCKS OF ONE OR MORE PROJECTS

(71) Applicant: Engineer.ai Corp., Salt Lake City, UT (US)

(72) Inventors: Sachin Dev Duggal, Salt Lake City, UT (US); Joseph Rifkin, Salt Lake City, UT (US); Sithara Priyadarshini, London (GB); Rohan Patel, London (GB)

(73) Assignee: Engineer.ai Corp., Salt Lake City, UT (US)

(21) Appl. No.: 18/323,412

(22) Filed: May 25, 2023

(51) Int. Cl. G06F 8/71; G06F 8/36

(52) U.S. Cl. CPC G06F 8/71; G06F 8/36

(57) ABSTRACT

Systems and methods for managing one or more building blocks of one or more projects is disclosed. The system includes a processor coupled to a memory. The processor is configured to receive a request for completing one or more projects. The request includes one or more features assigned for each project and one or more building blocks that implement the one or more features. The processor is further configured to assign one or more developers to complete the one or more projects. The one or more developers are assigned based on a selection criteria. The processor is further configured to capture one or more modifications made by the one or more developers to at least one building block. In addition, the processor is configured to generate a project pipeline that presents the one or more modifications captured.

### FIELD

This disclosure relates to project management, and more particularly to systems and methods for assembling one or more source codes of developed or developing features while working on one or more projects.

### BACKGROUND

Software project management relates to planning, scheduling, evaluating, and delivery of one or more projects assigned for completion. In the case of complex and lengthy projects, multiple developers/workers with different expertise would be required to work on the projects. Multiple developments and programming/coding would be expected during different stages of such projects. However, if one of the developers has to access previous development details and written code, this would be challenging as they would need to invest time in searching for the correct details. Further, it is important for the developers/workers to know about recent and past updates made in the project development and various libraries. Manual searching for each update will be a time-consuming task at their end. Thus, there is a need in the art for an improved solution for project management in which the developers/workers will have better access to project related data.

### SUMMARY

The disclosed subject matter relates to a system for assembling source codes of one or more projects. The system includes a processor coupled to a memory. The processor is configured to receive a request for accessing source codes of one or more features assigned for the one or more projects. The source codes are stored in a code repository. The processor is further configured to share development details of the source codes received from the code repository to one or more developers working on the one or more projects. The processor is further configured to determine one or more customizable areas of the source codes and present the one or more customizable areas to the one or more developers. In addition, the processor is configured to receive one or more upgrades made in the one or more customizable areas of the source codes.

The disclosed subject matter also relates to a method for assembling source codes of one or more projects. The method includes receiving a request for accessing source codes of one or more features assigned for the one or more projects. The source codes are stored in a code repository. The method further includes sharing development details of the source codes received from the code repository to one or more developers working on the one or more projects. The method further includes determining one or more customizable areas of the source codes and present the one or more customizable areas to the one or more developers. In addition, the method includes receiving one or more upgrades made in the one or more customizable areas of the source codes.

The disclosed subject matter also relates to a computer readable storage medium having data stored therein representing software executable by a computer, the software comprising instructions that, when executed, cause the computer readable storage medium to perform receiving a request for accessing source codes of one or more features assigned for the one or more projects. The source codes are stored in a code repository. The instructions further cause the computer readable storage medium to perform sharing development details of the source codes received from the code repository to one or more developers working on the one or more projects. The instructions further cause the computer readable storage medium to perform determining one or more customizable areas of the source codes and present the one or more customizable areas to the one or more developers. In addition, the instructions cause the computer readable storage medium to perform receiving one or more upgrades made in the one or more customizable areas of the source codes.

The disclosed subject matter further relates to a system for managing changes implemented in one or more projects. The system includes a processor coupled to a memory. The processor is configured to receive a request for completing one or more projects. The request includes one or more features assigned for each project and one or more building blocks that implement the one or more features. The processor is further configured to assign one or more developers to complete the one or more projects. The one or more developers are assigned based on a selection criteria. The processor is further configured to capture one or more modifications made by the one or more developers to at least one building block. In addition, the processor is configured to generate a project pipeline that presents the one or more modifications captured.

The disclosed subject matter also relates to a method for managing changes implemented in one or more projects. The method includes receiving a request for completing one or more projects. The request includes one or more features assigned for each project and one or more building blocks that implement the one or more features. The method further includes assigning one or more developers to complete the one or more projects. The one or more developers are assigned based on a selection criteria. The method further includes capturing one or more modifications made by the one or more developers to at least one building block. In addition, the method includes generating a project pipeline that presents the one or more modifications captured.

The disclosed subject matter also relates to a computer readable storage medium having data stored therein representing software executable by a computer, the software comprising instructions that, when executed, cause the computer readable storage medium to perform receiving a request for completing one or more projects. The request includes one or more features assigned for each project and one or more building blocks that implement the one or more features. The instructions further cause the computer readable storage medium to perform assigning one or more developers to complete the one or more projects. The one or more developers are assigned based on a selection criteria. The instructions further cause the computer readable storage medium to perform capturing one or more modifications made by the one or more developers to at least one building block. In addition, the instructions cause the computer readable storage medium to perform generating a project pipeline that presents the one or more modifications captured.

In addition, the disclosed subject matter relates to a system for managing one or more building blocks of one or more projects. The system includes a processor coupled to a memory. The processor is configured to receive a request for completing the one or more projects. The request includes one or more building blocks that implement the one or more features. The processor is further configured to monitor a usage pattern of the one or more building blocks. The processor is further configured to group the one or more building blocks into one or more categories based on their usage pattern. In addition, the processor is configured to assign the one or more building blocks to one or more other projects based on the usage pattern. One or more developers selected to complete the one or more other projects use the one or more building blocks to develop at least one feature in the one or more other projects.

The disclosed subject matter also relates to a method for managing one or more building blocks of one or more projects. The method includes receiving a request for completing the one or more projects. The request includes one or more building blocks that implement the one or more features. The method further includes monitoring a usage pattern of the one or more building blocks. The method further includes grouping the one or more building blocks into one or more categories based on their usage pattern. In addition, the method includes assigning the one or more building blocks to one or more other projects based on the usage pattern. One or more developers selected to complete the one or more other projects use the one or more building blocks to develop at least one feature in the one or more other projects.

The disclosed subject matter also relates to a computer readable storage medium having data stored therein representing software executable by a computer, the software comprising instructions that, when executed, cause the computer readable storage medium to perform receiving a request for completing the one or more projects. The request includes one or more building blocks that implement the one or more features. The instructions further cause the computer readable storage medium to perform monitoring a usage pattern of the one or more building blocks. The instructions further cause the computer readable storage medium to perform includes grouping the one or more building blocks into one or more categories based on their usage pattern. In addition, the instructions cause the computer readable storage medium to perform assigning the one or more building blocks to one or more other projects based on the usage pattern. One or more developers selected to complete the one or more other projects use the one or more building blocks to develop at least one feature in the one or more other projects.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a system in an embodiment of the disclosed subject matter.

FIG. 7 is a schematic illustrating an exploded view of the server of the system of FIG. 6 in an embodiment of the disclosed subject matter.

FIG. 8 illustrates a change screen illustrating changes made in the development codes of a project in an embodiment of the disclosed subject matter.

FIG. 9 illustrates a pipeline screen illustrating changes made in a project in an embodiment of the disclosed subject matter.

FIG. 10 is a flow diagram illustrating a method for assembling source codes of one or more projects in an embodiment of the disclosed subject matter.

FIG. 11 is a flow diagram illustrating a method for managing changes implemented in one or more projects in an embodiment of the disclosed subject matter.

FIG. 12 is a flow diagram illustrating a method for managing one or more building blocks of one or more projects in an embodiment of the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, well-known apparatus structures, and well-known techniques are not described in detail.

The terminology used, in the present disclosure, is for the purpose of explaining a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

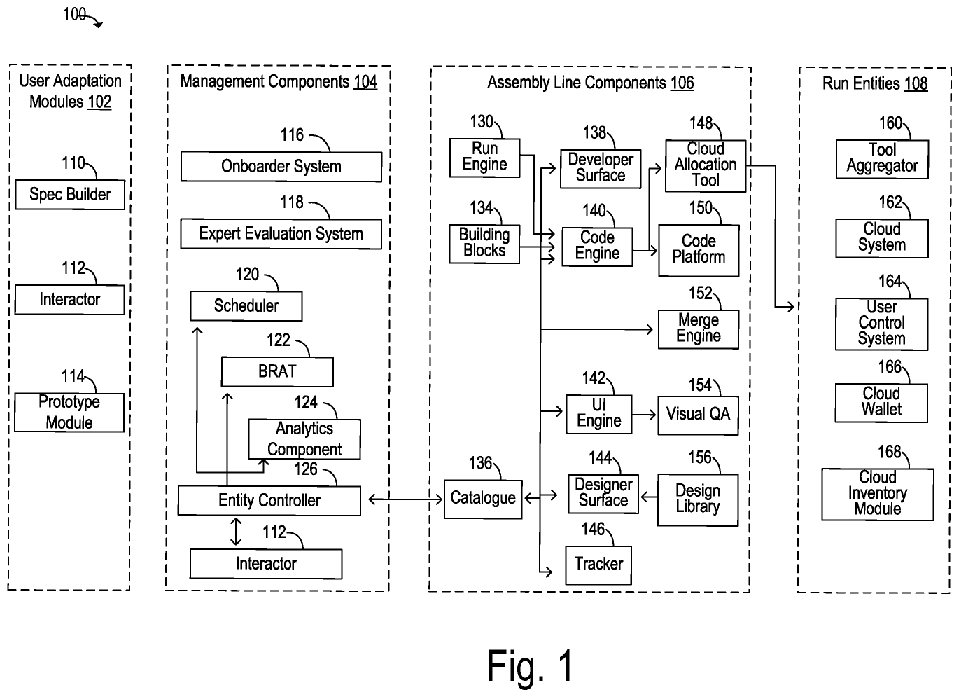

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100.

The user adaptation modules 102 may include a specification builder 110, an interactor 112 system, and the prototype module 114. They may be used to guide a user through a process of building software and managing a software project. The specification builder 110, the interactor 112 system, and the prototype module 114 may be used concurrently and/or link to one another. For instance, the specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

The specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases.

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to reduce the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return results.

The prototype module 114 may use a secondary machine learning algorithm to select a likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a good fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with critique and provide the onboarding system 116 with metrics with it can use to allocate the experts on future tasks.

Scheduler 120 keeps track of overall progress of a project and provides experts with job start and job completion estimates. In a complex project, some expert developers may be expected to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating developer assignments for all available parallel workstream across multiple projects. BRAT 122 system allows expert developers to be efficiently managed to reduce cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the top experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, the building block components 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

The visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services by users to build, run and scale their software project. For instance, it may aggregate software services from payment gateways and licenses such as Office 365. User accounts may be automatically provisioned for services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over all features of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user has to set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

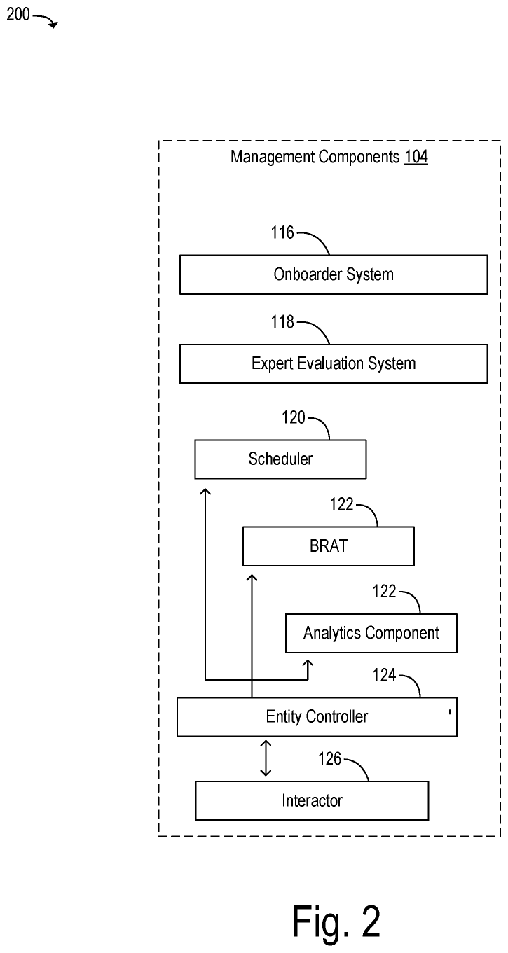

Referring to FIG. 2. FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

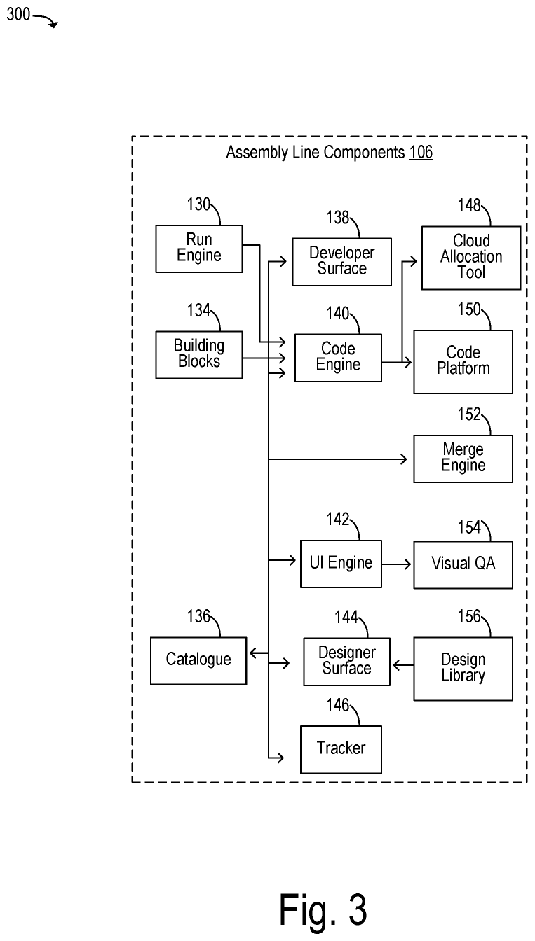

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

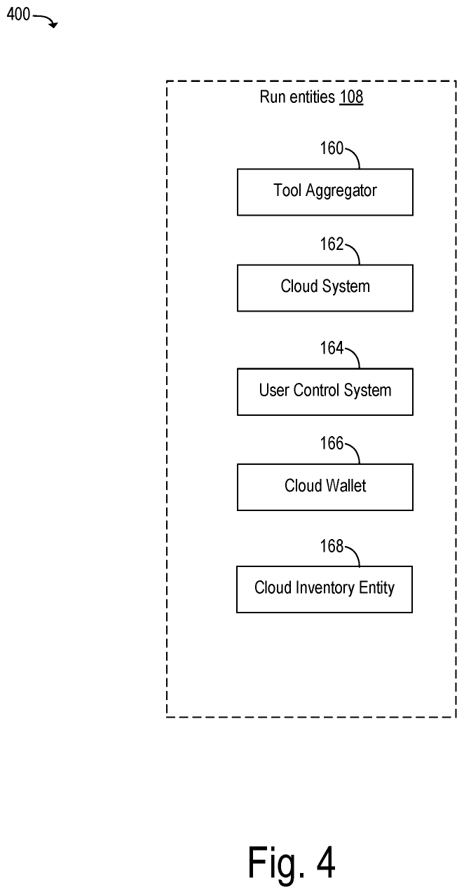

Referring to FIG. 4, FIG. 4 is a schematic 400 illustrating an embodiment of the run entities 108 of the software building system. The run entities 108 provides a user with 3rd party tools and services, inventory management, and cloud services in a scalable system that can be automated to manage a software project. In an exemplary embodiment, the run entities 108 is a cloud-based system that provides a user with all tools to run a project in a cloud environment.

For instance, the tool aggregator 160 automatically subscribes with appropriate 3rd party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

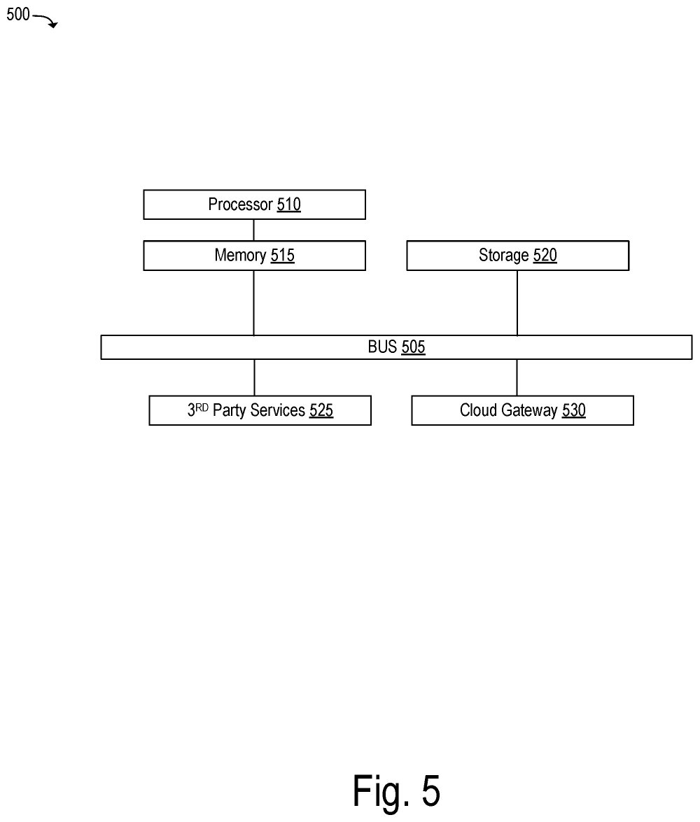

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, a processor 510 coupled to a memory 515, and a storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3rd party services such as Office 365 and Adobe. Similarly, users may access the computing system 500 via a cloud gateway 530. For instance, a user on a separate computing system may connect to the computing system 500 to access data, interact with the run entities 108, and even use 3rd party services 525 via the cloud gateway.

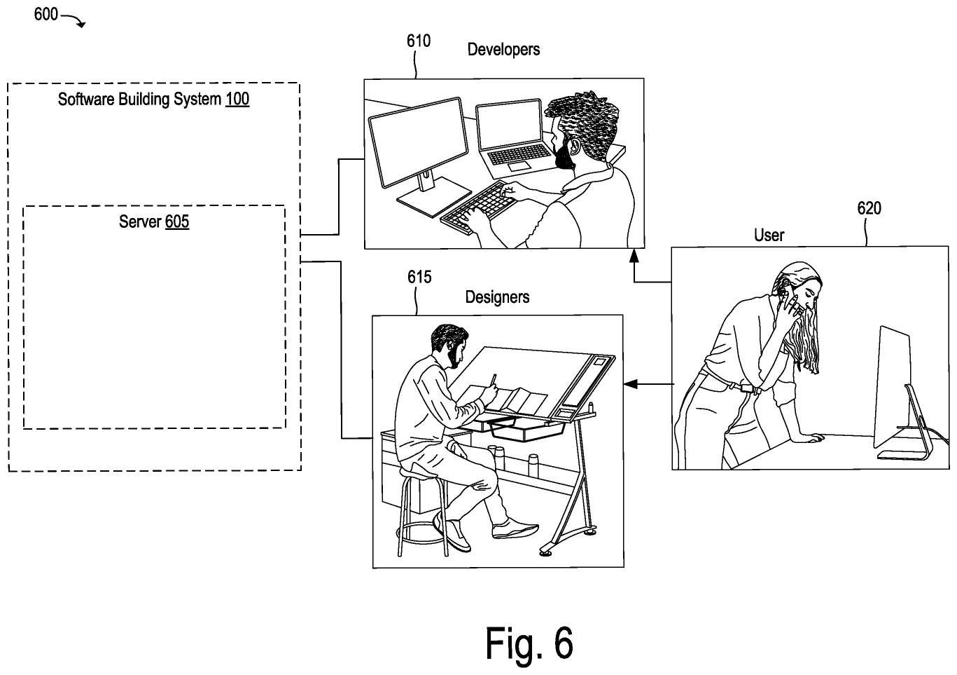

Referring to FIG. 6, FIG. 6 is a schematic diagram of a system 600 in an embodiment of the disclosed subject matter. In an exemplary embodiment, the system 600 comprises the software building system 100, one or more users 620, one or more developers 610, and one or more designers 615. In the embodiment shown for the system 600, the software building system 100 comprises a server 605. The server 605 may be a computing system 500.

In the exemplary embodiment shown in FIG. 6, the server 605 is in communication with one or more users 620, one or more developers 610, and one or more designers 615. Various embodiments may include additional personnel or computing resources that produce code, content, or the like for the software application. For example, the server 605 may be in communication with one or more quality assurance engineers to assemble, test, and package the software application.

In an exemplary embodiment, the server 605 may transfer allocating units to the users 620. The users 620, as used herein, may be referred to an individual person, small business owner/manager, large business owner/manager, hotel manager, restaurant manager, and the like. The users 620 may distribute the allocating units to various personnel, computing resources, or other services to work on the software application. In an exemplary embodiment, allocating units may be referred to as tokens, points, or the like. As used herein, the allocating units are commonly referred to as points.

In an exemplary embodiment, the users 620 may distribute points to developers 610 and designers 615. The developers 610, as used herein, may be referred to as experts, developer experts, coders, software engineers, engineers, and the like. In various embodiments, the one or more developers 610 may be supplied by an onboarding system 116. In various embodiments, the users 620 contact and selects the one or more developers 610.

In an exemplary embodiment, the BRAT 122 may determine the one or more developers 610 for a software project. In one implementation, the BRAT 122 may determine the one or more developers 610 for the users 620 based on multiple qualities of a software application and/or multiple software application visions. For instance, the BRAT 122 may determine the one or more developers 610 for a small-size software application, a medium-sized software application, and a large medium-sized software application. In another instance, the BRAT 122 may determine the one or more developers 610 for a consumer-based software application and an industry-based software application where a consumer-based software application has a focus on large volume consumer communication and an industry-based software application has a focus on intimate communication with a small number of industries.

The designers 615, as used herein, may be referred to as artists, web designers, and the like. The designers 615 may have different skill levels and different skill areas. In an exemplary embodiment, the BRAT 122 may provide the one or more designers 615 along with their talent set. A user may use the provided information on designers to allocate resources to designers 615 in a way that promotes the users 620 vision of the software application.

The system 600 allows the users 620 freedom to distribute points according to their vision and limited resources for the software application project. Accordingly, the system 600 maximizes creativity at a high level by allowing the users 620 strategic control over high-level management decisions in the software project. The users 620 is not limited to arbitrary or abstract criteria for selecting developers or designers or how to allocate points to developers or designers. Even where the cloud allocation tool 148 determines a number of points for the users 620, the system 600 provides for the users 620 to distribute those points without limitations.

The distribution of points from the users 620 to developers 610, designers 615, or the like is a signal to the developers 610 and designers 615 to provide an amount of work commensurate with the number of points transferred. The server 605 may provide lower management level decisions to the developers 610, designers 615, or other personnel or computing resources based on the points allocated to them by the users 620. In an exemplary embodiment, the server 605 may provide payment to the developers 610 and designers 615 based on the points distributed to them.

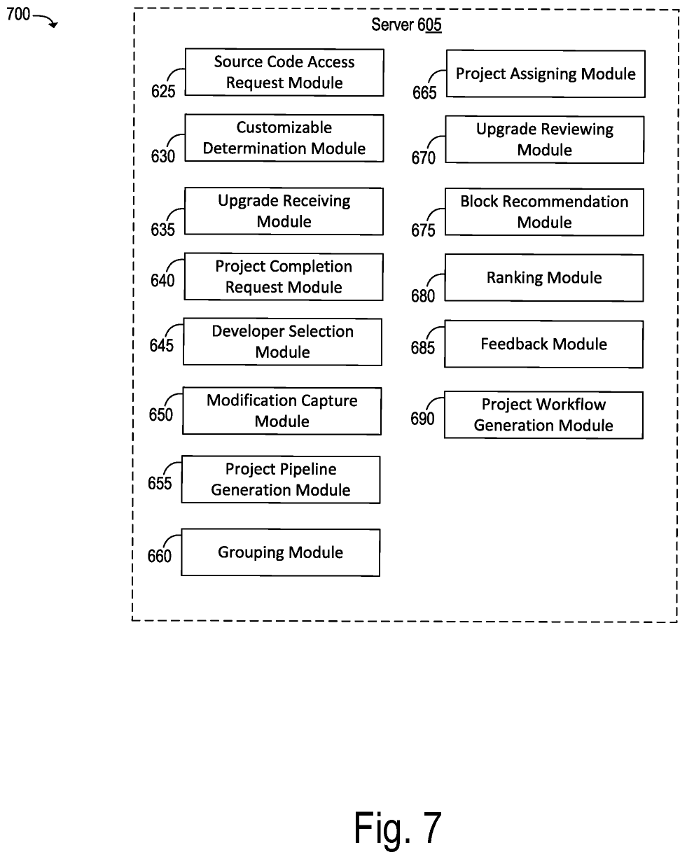

Referring to FIG. 7, FIG. 7 illustrates an exploded view 700 of the server 605 of the system 600 of FIG. 6 in an embodiment of the disclosed subject matter. As shown, the server 605 includes a source code access request module 625, a customizable determination module 630, an upgrade receiving module 635, a project completion request module 640, a developer selection module 645, a modification capture module 650, a project pipeline generation module 655, a grouping module 660, a project assigning module 665, an upgrade reviewing module 670, a block recommendation module 675, a ranking module 680, a feedback module 685, and a project workflow generation module 690. The functionality of each module is explained in further detail below.

In an exemplary embodiment, the source code access request module 625 receives a request for accessing source codes of one or more features assigned for the one or more projects. The request for accessing the one or more source codes is placed by the one or more developers 610, designers 615, or users 620 using their respective device (not shown). In an example, the device may include a mobile device, personal computer (PC), tablet, PDA, and the like. While placing the request, the developers 610, designers 615, or users 620 are required to mention the project name, feature name, names of the one or more building blocks, path, and the like while placing the request. This will make it easier for the source code access request module 625 to retrieve the correct source code from the code repository where the one or more source codes are stored. The building blocks are reusable pieces of code that implement partial functionalities of the one or more features assigned for each project. For example, the code may be written using C language, C++, Java, Phyton, or any appropriate programming language that is known to those skilled in the art. The building blocks created are shipped out to at least one project where they are required.

For instance, the one or more features may include a login feature, a security feature, a payment feature, a dashboard feature, and the like. The source codes correspond to programming statements or codes that are written by one or more developers 610 who developed/implemented features for each project. The source codes may include one or more parts such as variables, statements, comparisons, comments, and the like. The source codes may be written using one or more programming languages known to a person skilled in the art. Once the current sources codes are retrieved from the code repository, the source code access request module 625 shares them with the one or more developers 610 currently working on the one or more projects.

In an exemplary embodiment, the customizable determination module 630 determines one or more customizable areas of the one or more source codes received by the source code access request module 625. The customizable determination module 630 is capable of determining which parts of the source codes are core and which parts of the source codes are custom. This will make upgrading of the code easier for the one or more developers 610. The customizable areas of the source codes correspond to areas in which custom code may be inserted to patch up the design. The customizable areas may be presented to the one or more developers 610 using a different background or color than the background or color of the non-customizable areas of the source codes. For instance, the background or color of customizable areas may be red and the background or color of the non-customizable areas may be green. Further, comments may be inserted in the source codes stating that the customizable start and end areas. Such presentation of the customizable areas of the source codes will make it easier for the one or more developers 610 to make changes/modifications.

In an exemplary embodiment, the upgrade receiving module 635 receives one or more upgrades or modifications made in the one or more customizable areas of the source codes identified by the customizable determination module 630. The one or more developers 610 may make upgrades or modifications to the source codes for adding new features/content to the previously written source codes, improving the performance of the previously written source codes, making the previously written source codes more carbon friendly or environment friendly. fixing bugs or errors in the previously written source codes, and the like. For instance, the one or more developers 610 may make upgradations or modifications by adding new lines or code, removing previous lines of code, adding comments in the code, and the like. The upgrade receiving module 635 then saves the one or more upgradations or modifications made in the one or more customizable areas of the source codes in the code repository. The code repository may save the one or more upgrades or modifications using versions, which are created each time the source codes are changed. In this way, it will be easier for the one or more developers 610 to track when and what changes have been made to the source codes.

In an exemplary embodiment, the project completion request module 640 receives a request for completing the one or more projects. The request may include one or more features assigned for each project, one or more building blocks that implement the one or more features, a project location, a project timeline, and the like. The project location corresponds to one or more areas where the developers 610, designers 615, and users 620 may perform or execute the one or more projects. The project location may be set by the developers 610, designers 615, and users 620. Further, the server 605 is capable of identifying (in real-time) when the developers 610, designers 615, or users 620 are within a pre-defined threshold distance of the project location. In an example, the pre-defined threshold distance may be 1 km, 5 km, 10 km, 20 km, and the like. In case the developers 610, designers 615, or users 620 are outside the pre-defined threshold while working, the server 605 may raise an alert and request them to work within ranges. This is mainly due to security purposes. The project timeline corresponds to a visual list of one or more tasks, activities, and schedules depicting the plan for completion of the project. The project timeline may be represented in a graphical or tabular manner.

In an exemplary embodiment, the developer selection module 645 assigns or selects one or more developers 610 to complete the one or more projects. The one or more developers 610 are selected based on a selection criteria. The selection criteria includes at least one of a location of the one or more developers 610, experience of the one or more developers 610, and a performance of the one or more developers 610 in an expert onboarding assessment. The selection assessment refers to a test that is automatically generated by the server 605 that the one or more developers 610 are required to take. For instance, if the background of the one or more developers 610 is into programming and the works performed by them are primarily in C++ or Java programming languages, the expert onboarding assessment generated will largely cover questions in those areas. The performance of the one or more developers 610 in the expert onboarding assessment is crucial for allocating them to the appropriate projects to work on.

In an exemplary embodiment, the modification capture module 650 captures one or more modifications made by the one or more developers 610 to at least one building block of each project. The one or more modifications may include changes made in the source codes corresponding to the at least one building block, the code libraries of the building blocks, the modules of the building blocks, merging different components of different building blocks together, and the like. The modification capture module 650 presents the one or more modifications using a tabular format, written format, status of the modifications, and the like. Further, the modification capture module 650 may capture the one or more modifications on a timely basis. In an example, the timely basis may be 1 hour, 3 hours, 6 hours, 9 hours, 12 hours, 24 hours, 1 week, 1 month, 2 months, and the like. Such capturing and presentation of the one or more modifications by the modification capture module 650 enables a transparency between the one or more developers 610 and the one or more users 620 or project managers. Thus, the developers 610 will be able to clearly visualize areas of the projects that have been updated by them along with other persons associated with the projects.

In an exemplary embodiment, the project pipeline generation module 655 generates a project pipeline that presents the one or more modifications captured by the modification capture module 650. The project pipeline may be presented to the one or more developers 610 or users 620 in a vertical timetable format, where the recent changes, modifications, or updates with respect to the one or more projects is placed at the top. For instance, the project pipeline may include information such as which files/building blocks/source codes were updated or merged, dates in which the files/building blocks/source codes were updated, which developers 610 modified what files/building blocks/source codes, any approvals pending, reasons for the changes or modifications, and the like. All the information is consolidated and presented in a clear and understandable manner to the one or more developers 610. Thus, the project pipeline generated by the project pipeline generation module 655 enables the developers 610 or users 620 to clearly visualize the changes made across the one or more projects. This may thus lead to better company/firm management.

In an exemplary embodiment, the grouping module 660 first monitors a usage pattern of the one or more building blocks. The usage pattern corresponds to one or more changes made to the one or more building blocks of each project over a threshold time period. The grouping module 660 checks whether the one or more building blocks have been used or have been idle. In an example, the threshold time period may be 1 day, 1 week, 2 weeks, 1 months, 3 months, 6 months, 1 year, and the like. For instance, the one or more changes may include changing the functionality of the existing building blocks, adding new features to the existing building blocks, removing features from the existing building blocks, merging features from different building blocks, and the like.

Based on the usage pattern monitored, the grouping module 660 then groups the one or more building blocks into one or more categories based on their usage pattern analyzed. In an example, the one or more categories may include not used, less used, used, and highly used. The one or more building blocks that were idle and not modified/changed or used elsewhere are grouped in the not used category. The one or more building blocks in which some changes have been made are grouped in the less used category. The one or more building blocks in which an intermediate or average amount of changes have been made are grouped in the used category. The one or more building blocks in which many changes have been made during the threshold time period(s) are grouped in the highly used category. The categories in which the one or more building blocks are grouped may be presented to the one or more developers 610, designers 615, or users 620 in their respective devices. Such a grouping of the one or more building blocks allows them to see which building blocks are getting used and which building blocks are not getting used often and may be used for other tasks.

In an exemplary embodiment, the project assigning module 665 assigns the one or more building blocks to one or more other projects based on the usage pattern monitored and the categories in which they are grouped into by the grouping module 660. The project assigning module 665 first analyzes factors associated with the one or more other projects, where the factors may include project features, project complexity, project requirements, project deadlines, and the like. The project features and requirements correspond to one or more features, tasks, and assignments that the one or more developers 610 are requested too timely complete. For instance, the project assigning module 665 may check for overlapping features between the one or more projects and the one or more other projects, merges made between the features of the one or more projects, category that the one or more building blocks are grouped into by the grouping module 660, and the like.

In an example, project A of the one or more projects has building block A implemented for feature A, building block B implemented for feature B, and building block C implemented for feature C. Project B of the one or more other projects has feature D, feature B, and feature F that needs to be developed. Here, the project assigning module 665 first determines that feature B is common between Project A and Project B. The project assigning module 665 then receives the development details of the building block B from the code repository. Once received from the code repository, the project assigning module 665 checks the category of building block B. If the building block B is not used often and falls in the not used category or less used category, the project assigning module 665 may then recommend assigning the building block B for implementing feature B in Project B. The one or more developers 610 working on Project B may then use the development details of building block B to implement at least one feature/component in feature B of Project B. Thus, instead of rebuilding the same feature each time, the project assigning module 665 is capable of shipping out the common features to the appropriate other projects at appropriate instances. Further, the one or more modifications made to the one or more building blocks while working on the one or more other projects are saved in the code repository.

In an exemplary embodiment, the upgrade reviewing module 670 reviews the one or more upgrades received from the upgrade receiving module 635. The upgrade reviewing module 670 reviews the modifications made in the source codes, checks the functionality of the modified source codes, compiles the modified source codes, performs a carbon check or an environmental check of the modified source codes, and the like. Based on the above-mentioned revisions, the upgrade reviewing module 670 generates an upgradation score. The upgradation score is used for evaluating the goodness or functionality of the one or more upgrades. The upgradation score may be between the range of 0 to 100. The closer the upgradation score is to 100, better is the functionality of the upgrades as evaluated by the upgrade reviewing module 670.

In an exemplary embodiment, the block recommendation module 675 recommends one or more building blocks implemented in and associated with one or more previously developed projects to implement in the one or more projects currently being worked on by the one or more developers 610. The block recommendation module 675 also recommends one or more additional features to add to the one or more other projects based on the usage pattern monitored by the grouping module 660. In an example, if the one or more developers 610 are developing an e-commerce application and the one or more features being developed include a registration feature, a search feature, a product showcase feature, a detailed product information feature, a product review feature, a purchase feature, and the like. The block recommendation module 675 may then recommend adding additional features such as a voice assistant feature, a Wishlist feature, a customer support feature, and the like.

These additional blocks/features recommendations may be made based on an analysis of one or more parameters. For instance, the one or more parameters may include current trends, feedback from clients/customers, projects costs, project value, and the like. The current trends corresponds to recent changes or developments made in the one or more previously developed projects. The block recommendation module 675 analyzes different features being developed in similar applications to the one being developed currently. If few features present in the similar/previously developed applications are of value and have become increasingly used, the block recommendation module 675 recommends to the one or more developers 610 to add such features to the current projects that they are working on. The block recommendation module 675 also analyzes feedback or inputs received for different features developed in the similar/previously developed applications.

In an exemplary embodiment, the ranking module 680 ranks the one or more projects in an order of prioritization. The one or more projects may be ranked based on the project pipeline generated by the project pipeline generation module 655 and one or more parameters. The one or more parameters may include a risk distribution, a project value, a project speed, project deadlines, and the like. The risk distribution refers to one or more activities conducted to reduce project risks. The project risks may include operational risk, financial risk, and underwriting risk. The project value corresponds to the value that each project holds to the project managers, stakeholders, clients, customers, and the like. The project value may be determined based on one or more parameters such as earned value, planned value, project cost, delays in the project, and the like. Further, the project speed and proximity to a completion deadline both monitor the current progress of each project, whether the deadlines are met, issues/concerns raised by the developers 610. designers 615, and users 620, targets set by the project managers, achievements, and the like.

In an exemplary embodiment, the feedback module 685 provides feedback to the one or more developers 610 based on the one or more modifications captured by the modification capture module 650. In an example, the feedback may be real-time feedback or live feedback in which the feedback module 685 is able to directly interact with the one or more developers 610. The feedback may be presented to the one or more developers 610 via at least one of a written message, an audio message, an email message, and the like. The feedback may be presented to the one or more developers 610 on their respective device (not shown) while working on the one or more projects. In an example, if the modifications made by the developers 610 have less errors/bugs, the feedback module 685 may then prompt a message stating, “Good Work” or “Less Errors Found, Keep it Up”. Such feedback may motivate the one or more developers 610 to perform better and also ensure that they remain concentrated.

In an exemplary embodiment, the project workflow generation module 690 generates a project workflow for completing the one or more projects. The project workflow includes a sequence of tasks that need to be completed for the one or more developers 610 to timely complete the projects. The generated project workflow may be communicated to the one or more developers 610 using a queue. In an example, the queue may be an AWS SNS queue, an AWS SQS queue, and the like. With the use of the queue, the one or more developers 610 will know which projects are new or having a priority as determined by the ranking module 680, and what work needs to be done them.

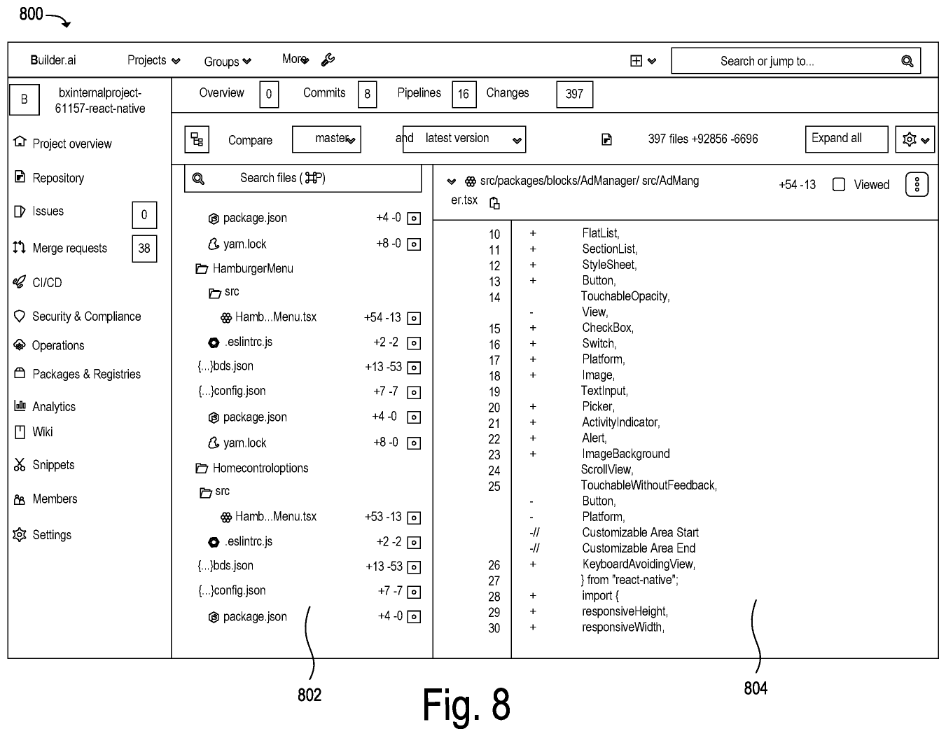

Referring to FIG. 8, FIG. 8 illustrates a change screen 800 illustrating changes made in the development codes of a project in an embodiment of the disclosed subject matter. As shown, the change screen 800 includes code file presentation area 802 and a source code presentation area 804. The code file presentation area 802 shows the one or more code files in which the one or more source codes have been developed and saved. The one or more code files may be developed and saved using JSON, react, JS, and the like. The code file presentation area 802 mentions all the features developed for each project along with the code files for each feature. The developers 610 need to double click on the code files to view the source codes.

The source code presentation area 804 is displayed upon double click of the source codes displayed in the code file presentation area 802. The source code presentation area displays the source codes for each feature of each project. The developers 610 will be able to view further details of the source codes upon clicking a dash symbol alongside each feature in the source code presentation area 804. Further, the source code presentation area 804 also displays the customizable areas and non-customizable areas of the source codes for each feature. The background or color of customizable areas may be red and the background or color of the non-customizable areas may be green. Further, comments may be inserted in the source codes stating where the customizable start and end areas. Such presentation of the customizable areas of the source codes will make it easier for the one or more developers 610 to modify the codes whenever required.

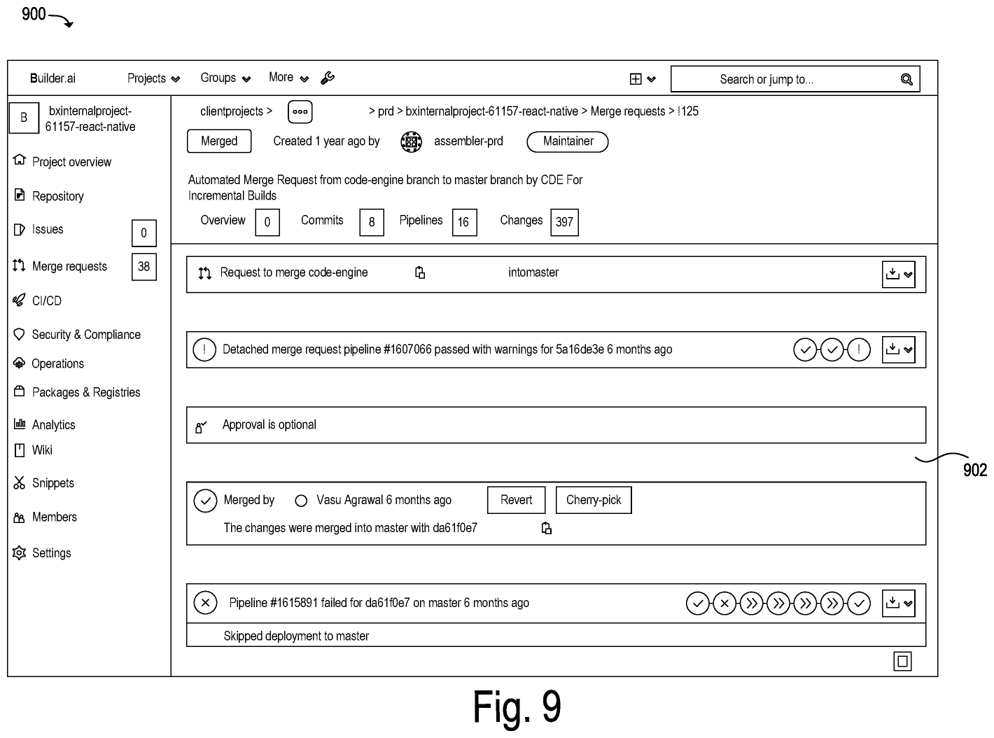

Referring to FIG. 9, FIG. 9 illustrates a pipeline screen 900 illustrating changes made in a project in an embodiment of the disclosed subject matter. As shown, the pipeline screen 900 includes the project pipeline 902 that represents the one or more modifications captured for each project. The project pipeline may be presented to the one or more developers 610 or users 620 in a vertical timetable format, where the recent changes, modifications, or updates with respect to the one or more projects is placed at the top. For instance, the project pipeline may include information such as which files/building blocks/source codes were updated or merged, dates in which the files/building blocks/source codes were updated, which developers 610 modified what files/building blocks/source codes, any approvals pending, reasons for the changes or modifications, and the like.

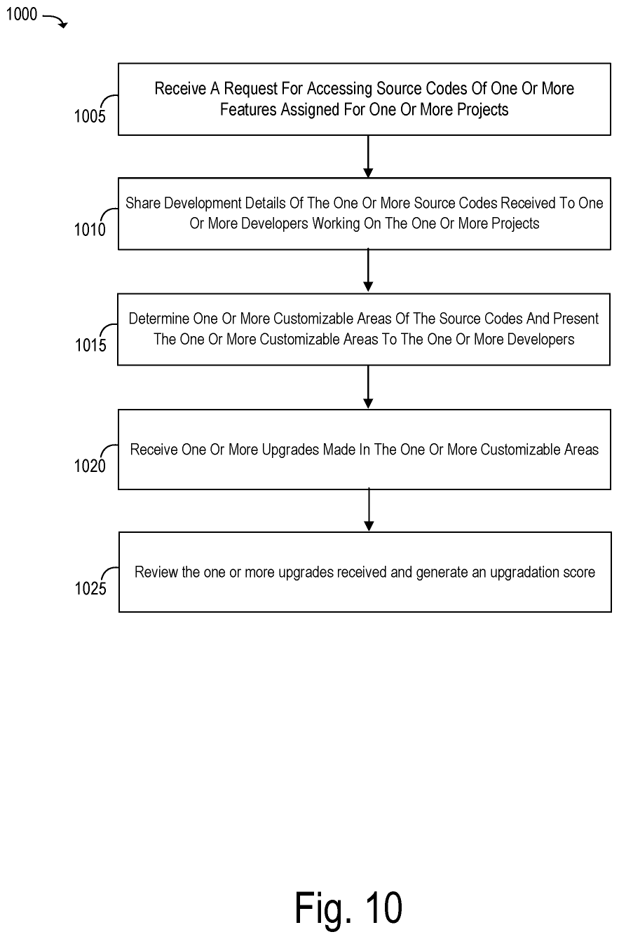

Referring to FIG. 10, FIG. 10 is a flow diagram 1000 of an embodiment of the disclosed subject matter. The flow diagram 1000 illustrates a method for assembling source codes of one or more projects. The software application may be any executable process on a computer system comprising instructions, designs, art, user interfaces, audio recordings, music, video, and the like. The software application is not limited to any commercial or consumer application. For example, the software application may be a utility application, a production application, a document generator, a game, and artistic application, and accounting application, or the like. Steps 1005-1025 of the flow diagram 1000 may be executed using the server 605 of FIGS. 6-7. Each step is explained in further detail below.

At step 1005, a request for accessing source codes of one or more features assigned for one or more projects is received from the one or more developers 610, designers 615, or users 620. While placing the request, the developers 610, designers 615, or users 620 are required to mention the project name, feature name, names of the one or more building blocks, path, and the like while placing the request. This will make it easier to retrieve the correct source code from the code repository where the one or more source codes are stored.

At step 1010, development details of the one or more source codes retrieved from the code repository in step 1005 are shared to the one or more developers 610 currently working on the one or more projects. The development details correspond to the software development lifecycle of the features of each project. In an example, the development details may include information such as code development details for implementing each feature or block of the one or more projects, modifications made in the written codes by the one or more developers 610, details of the one or more developers 610 who developed the codes, project details, time taken to develop different stages of the project, and the like.

At step 1015, one or more customizable areas of the one or more source codes received in step 1010 are determined. The customizable areas of the source codes correspond to areas in which custom code may be inserted to patch up the design. The customizable areas may be presented to the one or more developers 610 using a different background or color than the background or color of the non-customizable areas of the source codes. For instance, the background or color of customizable areas may be red and the background or color of the non-customizable areas may be green.

At step 1020, one or more upgrades or modifications made in the one or more customizable areas of the source codes are received. The one or more developers 610 may make upgrades or modifications to the source codes for adding new features/content to the previously written source codes, improving the performance of the previously written source codes, making the previously written source codes more carbon friendly or environment friendly, fixing bugs or errors in the previously written source codes, and the like. For instance, the one or more developers 610 may make upgradations or modifications by adding new lines or code, removing previous lines of code, adding comments in the code, and the like. The one or more upgradations or modifications made in the one or more customizable areas of the source codes are then saved in the code repository.

At step 1025, the one or more upgrades or modifications made in the one or more source codes are reviewed. The reviewing includes reviews the modifications made in the source codes, checks the functionality of the modified source codes, compiles the modified source codes, performs a carbon check or an environmental check of the modified source codes, and the like. Based on the above-mentioned revisions, an upgradation score is generated. The upgradation score is used for evaluating the goodness or functionality of the one or more upgrades. The upgradation score may be between the range of 0 to 100.

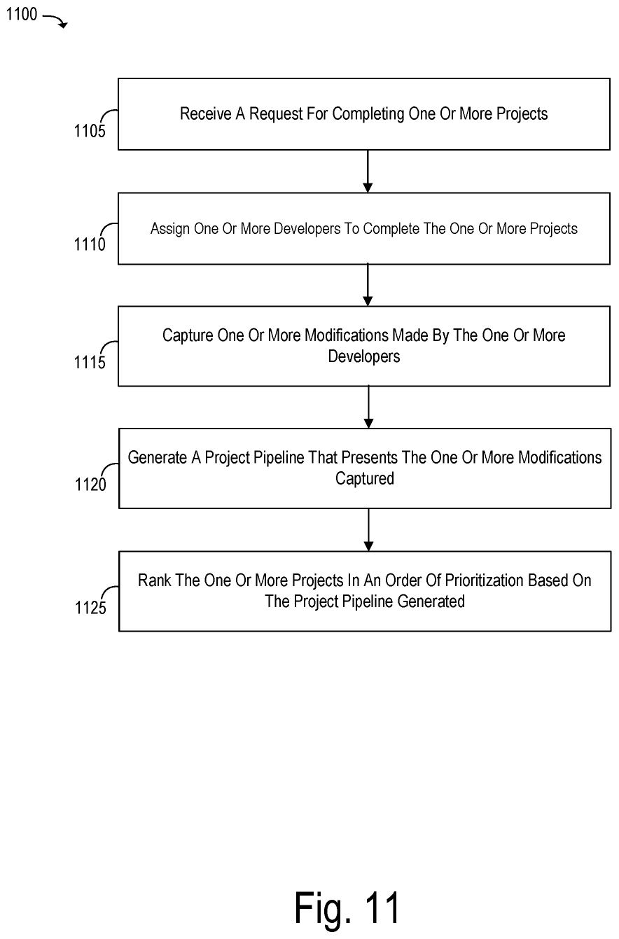

Referring to FIG. 11, FIG. 11 is a flow diagram 1100 of an embodiment of the disclosed subject matter. The flow diagram 1100 illustrates a method for managing changes implemented in one or more projects. Steps 1105-1125 of the flow diagram 1100 may be executed using the server 605 of FIGS. 6-7. Each step is explained in further detail below.

At step 1105, a request for completing the one or more projects is received. The request may include one or more features assigned for each project, one or more building blocks that implement the one or more features, a project location, a project timeline, and the like.

At step 1110, one or more developers 610 are assigned or selected to complete the one or more projects. The one or more developers 610 are selected based on a selection criteria. The selection criteria includes at least one of a location of the one or more developers 610, experience of the one or more developers 610, and a performance of the one or more developers 610 in an expert onboarding assessment. The selection assessment refers to a test that is automatically generated by the server 605 that the one or more developers 610 are required to take. The performance of the one or more developers 610 in the expert onboarding assessment is crucial for allocating them to the appropriate projects to work on.

At step 1115, one or more modifications made by the one or more developers 610 to at least one building block of each project are captured. The one or more modifications may include changes made in the source codes corresponding to the at least one building block, the code libraries of the building blocks, the modules of the building blocks, merging different components of different building blocks together, and the like. The one or more modifications may be presented using a tabular format, written format, status of the modifications, and the like. Further, the one or more modifications may be captured on a timely basis. In an example, the timely basis may be 1 hour, 3 hours, 6 hours, 9 hours, 12 hours, 24 hours, 1 week, 1 month, 2 months, and the like.

At step 1120, a project pipeline that presents the one or more modifications captured in step 1115 is generated. The project pipeline may be presented to the one or more developers 610 or users 620 in a vertical timetable format, where the recent changes, modifications, or updates with respect to the one or more projects is placed at the top. For instance, the project pipeline may include information such as which files/building blocks/source codes were updated or merged, dates in which the files/building blocks/source codes were updated, which developers 610 modified what files/building blocks/source codes, any approvals pending, reasons for the changes or modifications, and the like. All the information is consolidated and presented in a clear and understandable manner to the one or more developers 610.

At step 1125, the one or more projects are ranked in an order of prioritization. The one or more projects may be ranked based on the project pipeline generated in step 1120 and one or more parameters. The one or more parameters may include a risk distribution, a project value, a project speed, project deadlines, and the like.

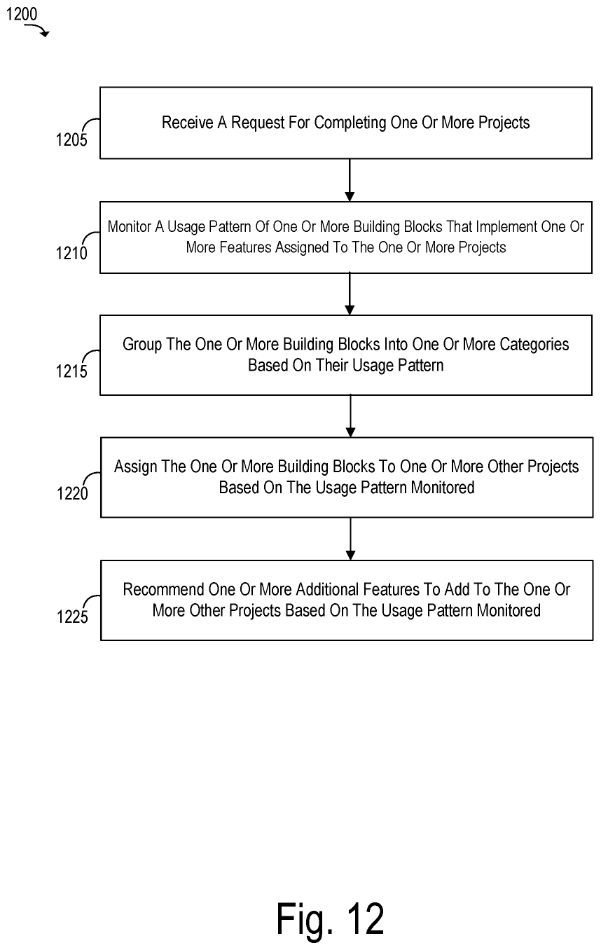

Referring to FIG. 12, FIG. 12 is a flow diagram 1200 of an embodiment of the disclosed subject matter. The flow diagram 1200 illustrates a method for managing one or more building blocks of one or more projects. Steps 1205-1225 of the flow diagram 1200 may be executed using the server 605 of FIGS. 6-7. Each step is explained in further detail below.

At step 1205, a request for completing the one or more projects is received. The request may include one or more features assigned for each project, one or more building blocks that implement the one or more features, a project location, a project timeline, and the like.

At step 1210, a usage pattern of the one or more building blocks is monitored. The usage pattern corresponds to one or more changes made to the one or more building blocks of each project over a threshold time period. The server 605 checks whether the one or more building blocks have been used or have been idle. In an example, the threshold time period may be 1 day, 1 week. 2 weeks, 1 months, 3 months, 6 months, 1 year, and the like. For instance, the one or more changes may include changing the functionality of the existing building blocks, adding new features to the existing building blocks, removing features from the existing building blocks, merging features from different building blocks, and the like.

At step 1215, the one or more building blocks are grouped into one or more categories based on their usage pattern analyzed. In an example, the one or more categories may include not used, less used, used, and highly used. The one or more building blocks that were idle and not modified/changed or used elsewhere are grouped in the not used category. The one or more building blocks in which some changes have been made are grouped in the less used category. The one or more building blocks in which an intermediate or average amount of changes have been made are grouped in the used category. The one or more building blocks in which many changes have been made during the threshold time period(s) are grouped in the highly used category. The categories in which the one or more building blocks are grouped may be presented to the one or more developers 610, designers 615, or users 620 in their respective devices.

At step 1220, the one or more building blocks for which the usage pattern monitored in step 1215 are assigned to one or more other projects based on the usage pattern monitored and the categories in which they are grouped into. The server 605 first analyzes factors associated with the one or more other projects, where the factors may include project features, project complexity, project requirements, project deadlines, and the like. The project features and requirements correspond to one or more features, tasks, and assignments that the one or more developers 610 are requested too timely complete. For instance, the server 605 may check for overlapping features between the one or more projects and the one or more other projects, merges made between the features of the one or more projects, category that the one or more building blocks are grouped into by the grouping module 660, and the like. Further, the one or more modifications made to the one or more building blocks while working on the one or more other projects are saved in the code repository.

At step 1225, one or more additional features to add to the one or more other projects are recommended. These additional blocks/features recommendations may be made based on an analysis of one or more parameters. For instance, the one or more parameters may include current trends, feedback from clients/customers, projects costs, project value, and the like. Further, these additional features may be presented to the one or more developers 610 while they are working using at least one of a written message, an audio message, an email message, and the like. This will thus help grab their attention quickly.

The system and method described herein is capable of retrieving one or more source codes developed for features of one or more projects and presenting these retrieved source codes to the developers or customers to see. The developers may then make one or more modifications to one or more customizable areas of the source codes. The system and method described herein is capable of determining which parts of the source codes are core and which parts of the source codes are custom. This will make upgrading of the code easier for the developers. Further, the system and method described herein is capable of presenting the determined customizable areas of the source codes using a different background or color than the background or color of the non-customizable areas of the source codes. Such presentation of the customizable areas of the source codes will make it easier for the developers to make changes/modifications.

The system and method described herein is also capable of capturing one or more modifications made by the developers to different building blocks that implement features of each project. The project pipeline may include information such as which files/building blocks/source codes were updated or merged, dates in which the files/building blocks/source codes were updated, which developers modified what files/building blocks/source codes, any approvals pending, reasons for the changes or modifications, and the like. All the information is consolidated and presented in a clear and understandable manner to the one or more developers. Thus, the project pipeline generated enables the developers and customers to clearly visualize the changes made across the one or more projects. This will be helpful for future situations in which they would need to refer back to previous project history.

Further, the system and method described herein is capable of monitoring a usage pattern of different building block previously developed/implemented for one or more projects. The usage pattern corresponds to one or more changes made to the one or more building blocks of each project over a threshold time period. Based on the monitored usage pattern, the one or more building blocks may then be assigned to one or more other projects where they could be of use. The developers may use the development details of the building block(s) to develop the feature(s) in the one or more other projects as assigned by the system and method described herein. The building blocks assigned are generally ones that are not used often or need to be updated in other projects. Thus, the developers need not start from scratch as the development details of the features previously developed will be made available to them. They need to build on top of these development details.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and such modifications are considered to be within the scope of the present disclosure.

The embodiments herein and the various features and advantageous details thereof are explained with reference to the non-limiting embodiments in the following description. Descriptions of well-known components and processing techniques are omitted so as to not obscure the embodiments herein. The examples used herein are intended merely to facilitate an understanding of ways in which the embodiments herein may be practiced and to further enable those of skill in the art to practice the embodiments herein. Accordingly, the examples may not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications may and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any of these matters form a part of the prior art base or were common general knowledge in the field relevant to the disclosure as it existed anywhere before the priority date of this application.

The numerical values mentioned for the various physical parameters, dimensions or quantities are approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the embodiments, it will be appreciated that many embodiments can be made and that many changes can be made in the embodiments without departing from the principles of the disclosure. These and other changes in the embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for managing one or more building blocks of one or more projects, the system comprising:
a processor coupled to a memory, the processor configured to:
receive a request for completing the one or more projects, wherein the request includes one or more building blocks that implement one or more features assigned to the one or more projects;
monitor a usage pattern of the one or more building blocks;
group the one or more building blocks in to one or more categories based on their usage pattern; and
assign the one or more building blocks to one or more other projects based on the usage pattern, wherein one or more developers selected to complete the one or more other projects use the one or more building blocks to develop at least one feature in the one or more other projects.

2. The system of claim 1, wherein the one or more building blocks are reusable pieces of code that implement partial functionalities of the one or more features assigned for each project.

3. The system of claim 1, wherein the usage pattern of the one or more building blocks is monitored for a threshold time period.

4. The system of claim 1, wherein the processor is configured to recommend one or more additional features to add to the one or more other projects based on the usage pattern.

5. The system of claim 1, wherein the processor is further configured to save one or more modifications made to the one or more building blocks while working on the one or more other projects.

6. The system of claim 5, wherein the processor is configured to review the one or more modifications made to the one or more building blocks.

7. The system of claim 6, wherein the processor is further configured to provide feedback upon review of the one or more modifications made, wherein the feedback is provided using at least one of a written message, an audio message, and an email message.

8. A method for managing one or more building blocks of one or more projects, the method comprising:
receiving a request for completing the one or more projects, wherein the request includes one or more building blocks that implement one or more features assigned to the one or more projects;
monitoring a usage pattern of the one or more building blocks;
grouping the one or more building blocks in to one or more categories based on their usage pattern; and
assigning the one or more building blocks to one or more other projects based on the usage pattern, wherein one or more developers selected to complete the one or more other projects use the one or more building blocks to develop at least one feature in the one or more other projects.

9. The method of claim 8, wherein the one or more building blocks are reusable pieces of code that implement partial functionalities of the one or more features assigned for each project.

10. The method of claim 8, wherein the usage pattern of the one or more building blocks is monitored for a threshold time period.

11. The method of claim 8, further comprising recommending one or more additional features to add to the one or more other projects based on the usage pattern.

12. The method of claim 8, further comprising saving one or more modifications made to the one or more building blocks while working on the one or more other projects.

13. The method of claim 12, further comprising reviewing the one or more modifications made to the one or more building blocks.

14. The method of claim 13, further comprising providing feedback upon review of the one or more modifications made, wherein the feedback is provided using at least one of a written message, an audio message, and an email message.

15. A computer readable storage medium having data stored therein representing software executable by a computer, the software comprising instructions that, when executed, cause the computer readable storage medium to perform:
receiving a request for completing one or more projects, wherein the request includes one or more building blocks that implement one or more features assigned to the one or more projects;
monitoring a usage pattern of the one or more building blocks;
grouping the one or more building blocks in to one or more categories based on their usage pattern; and
assigning the one or more building blocks to one or more other projects based on the usage pattern, wherein one or more developers selected to complete the one or more other projects use the one or more building blocks to develop at least one feature in the one or more other projects.

16. The computer readable storage medium of claim 15, wherein the one or more building blocks are reusable pieces of code that implement partial functionalities of the one or more features assigned for each project.

17. The computer readable storage medium of claim 15, wherein the usage pattern of the one or more building blocks is monitored for a threshold time period.

18. The computer readable storage medium of claim 15, wherein the instructions further cause the computer readable storage medium to perform recommending one or more additional features to add to the one or more other projects based on the usage pattern.

19. The computer readable storage medium of claim 18, wherein the instructions further cause the computer readable storage medium to perform saving one or more modifications made to the one or more building blocks while working on the one or more other projects.

20. The computer readable storage medium of claim 19, wherein the instructions further cause the computer readable storage medium to perform reviewing the one or more modifications made to the one or more building blocks.
